(19) United States
(12) Patent Application Publication
(10) Pub. No.: US 2010/0093581 A1
(43) Pub. Date: Apr. 15, 2010

(54) All Purpose Cleaning Compositions

(75) Inventors: Anthony E. Winston, East Brunswick, NJ (US); Norman Usen, Marlboro, NJ (US)

Correspondence Address: FRENKEL & ASSOCIATES, 3975 UNIVERSITY DR., STE. 330, FAIRFAX, VA, 22030, US

(73) Assignee: RUBI ROSE, LLC., New York, NY (US)

(21) Appl. No.: 12/251,564

(22) Filed: Oct. 15, 2008

(51) Int. Cl. C11D 3/20; C11D 3/50; C11D 17/00

(52) U.S. Cl. 510/107; 510/405; 510/434; 510/442

(57) ABSTRACT

An environmentally friendly, human safe, aqueous-based cleaning composition which can be formulated for cleaning a variety of substrates comprises an alkyl polyglycoside nonionic surfactant, and an alkyl amphocarboxylate surfactant. The composition is free of hydrocarbon solvents, contains a minimal amount of organic polar solvents, and contains naturally derived adjuvants such as chelating agents, fragrances, and buffers.

### FIELD OF INVENTION

This invention relates to an environmentally friendly, human safe, all purpose, aqueous cleaning composition which is designed to remove food residue, dirt, oils, and greases from surfaces like dishes, bottles, cooking surfaces, such as pots, pans, griddles, countertops, and other hard surfaces, as well as from textile surfaces when in detergent form, while maintaining good foaming, grease cutting, rinsing and mildness properties.

### BACKGROUND OF THE INVENTION

As is known to those skilled in the art to which the present invention pertains, a vast array of industrial chemicals are oil- or petrochemical-derived. One of the most important classes of such petrochemical-derived chemicals are surfactants or surface active agents and, especially, nonionic surfactants. There are an almost infinite number of nonionic surfactants available in the marketplace with varying properties ranging from low to high HLB, foamers, non-foamers, defoamers, wetting agents, emulsifiers, detergents and the like. The nonionic surfactants have their properties tailored by virtue of both the hydrophile and hydrophobe as well as the hydrophobe-hydrophile balance imparted thereto during the synthesis thereof. By tailoring not only the hydrophile and the hydrophobe, per se, but the hydrophile-hydrophobe balance, the inherent properties of the resulting chemical can be prescribed to meet the exigencies of the situation and the desired result. There are also a wide variety of anionic and amphoteric surfactants, many of which are manufactured from petrochemical-derived chemicals. These surfactants are usually but not always higher foamers than their nonionic counterparts.

Ordinarily, the hydrophobe or water-insoluble portion of the surfactant is derived from two main sources. Traditionally, the aromatic hydrophobes, such as the alkyl bezene, alkylphenol and the diphenylethers which are petrochemical-derived comprise the first class of hydrophobes.

The second source or class of hydrophobes are the aliphatic hydrophobes which do not contain an aromatic ring. Many, but not all of these are “naturally occurring” hydrophobes. The natural aliphatic hydrophobes consist of even numbered carbon chains. The synthetic hydrophobes generally contain both even and odd numbers of carbon atoms. Of special interest to this invention are those fatty acids and their derivatives, such as fatty alcohols, fatty amides and fatty amines, which are “naturally occurring,” or “naturally derived.”

The non-natural petroleum derived hydrophobic compounds come from non-renewable sources and many are manufactured by processes which may release undesirable chemicals into the environment. Additionally, many of the synthetic hydrocarbon based hydrophobes, especially those with branched chains, are resistant to biodegradation and some leave residues which are harmful to fish and other wild life. Also ingestion or absorption into the human body of synthetic surfactants from petroleum sources could lead to toxic effects, because the natural pathways for the complete breakdown of these surfactants are not available to all synthetic compounds. Partial biodegradation can lead to the formation of harmful residues. Therefore, there is significant interest in replacing petrochemical based hydrophobes with naturally occurring hydrophobes.

Not all naturally derived hydrophobes have all the positive characteristics of entirely natural ingredients. For example, there is known at least one natural terpene-derived hydrophobe but which has been propoxylated to increase hydrophobicity, thereby somewhat reducing the desirability of using this “naturally derived” surfactant.

The other component of a surfactant is the hydrophile. The most common hydrophile for a nonionic surfactant is obtained by a polymerization addition of an alkylene oxide, such as, for example, ethylene oxide and/or propylene oxide or other lower alkylene oxide to the hydrophobe. The oxide addition is either random or sequential. In any event, though, all alkylene oxides are petrochemical-derived. Importantly, ethoxylated surfactants may have residues of dioxane present, which is a toxic chemical even at fairly low doses.

In seeking alternate natural sources of hydrophilicity, the art has reported two significant examples thereof. First, there are the glucosamides. These are well known and used regularly in hand dish detergents. Similarly, the gluconic acid-derived surfactants, such as methyl glucoside surfactants are commercially available and are widely known. In either event, the glucosamides and the gluconic acid-derived surfactants have as their starting material basic naturally occurring sugars, i.e., glucose.

There is presently known and commercially available certain sugar-derived (glucose and sucrose) surfactants having a C₈₋₁₆ fatty alcohol hydrophobe and a glucose hydrophile. These compounds are known as alkyl polyglucosides (APGs). They are well-known and commercially available from a variety of sources including Cognis, Akzo Nobel, and Uniqema.

The APGs are petrochemical-free. They provide excellent detergency and are excellent foamers. Hydrophilicity is created by the addition of moieties with oxygen atoms to the hydrophobe. With APGs, oxygen atoms are present as hydroxyl groups, i.e. —OH. Thus, each glucose unit added to the alkyl portion of the surfactant adds three to four hydroxyl groups and the attendant increase in hydrophilicity. This is to be contrasted with typical ethoxylated surfactants where hydrophilicity is generated by adding single oxygen atoms as ether groups which are added individually to the polymer, thus, enabling control of the degree of hydrophilicity.

Surfactants are an important constituent in all cleaning formulations, in particular, formulations that are aqueous based in which the carrier for the active components is water, and organic solvents are used in minor amounts, if at all. Aqueous-based cleaning formulations that do not contain even moderate levels of volatile organic solvents are safer to the user and more eco-friendly than strictly organic solvent-based formulations. However, since many of the cleaning actives and adjuvants for such cleaning compositions are organic, it can be difficult to provide stable aqueous formulations that are acceptable to the consumer and maintain effectiveness.

It would be useful to provide all purpose aqueous-based cleaning compositions including cleaners useful as liquid dish detergents for hand washing, hard surface cleaners and laundry detergents, which are formed from natural sources and which are effective in removing a wide variety of contaminants, such as dried or wet food residues, dirt, oil, grease, etc from various types of surfaces. Moreover, such compositions should be essentially free of volatile organic solvents, not leave a toxic residue on the surface which is being cleaned, and be sufficiently mild and non-irritating to the skin. The compositions should also be effective in all types of applicators including, pour, squeeze, spray, wipers, etc.

### SUMMARY OF THE INVENTION

In accordance with the present invention, environmentally friendly, human safe, aqueous all purpose cleaning compositions are provided which are formed from naturally occurring components including an alkyl polyglycoside nonionic surfactant and an amphoteric surfactant comprising an alkyl amphocarboxylate to increase foaming, help solubilize the nonionionic surfactant in the concentrate and to reduce the formulation's skin and eye irritancy. The compositions of the present invention are essentially free of volatile organic solvents such as alcohols, glycols, ethers, etc., are free of hydrocarbon solvents and as well, essentially free of ethoxylated surfactants. The compositions of this invention are effective in removing all types of dirt, food residues, oils, and greases from hard surfaces, fabrics or skin, can be formulated inter alia as a liquid dish, a hand cleaner, an all purpose cleaner, a window cleaner or as a laundry detergent. The naturally derived cleaners of this invention have a reduced toxicity, are mild to the skin and eyes and do not leave a toxic residue on surfaces after cleaning and they are environmentally friendly. They can be formulated to be applied from a squeeze bottle, spray bottle, pour bottle or can be applied onto a woven or non-woven surface effective to contain the composition for wiping onto a surface for cleaning.

### DETAILED DESCRIPTION OF THE INVENTION

The all purpose cleaning compositions of this invention are aqueous-based. Although it is preferred that the compositions remain free of volatile solvents, it may be useful in some instances to include up to about 1 wt. %, preferably less than 0.75 wt. % of one or more organic polar solvents including lower C₂ to C₄ alcohols, C₂ to C₆ glycols, and alkyl glycol ethers. For example, non-limiting solvents selected from the group consisting of ethanol, mono-propylene glycol mono-propyl ether, mono-propylene glycol mono-butyl ether di-propylene glycol mono-propyl ether, di-propylene glycol mono-butyl ether; tri-propylene glycol mono-butyl ether; ethylene glycol mono-butyl ether; di-ethylene glycol mono-butyl ether, ethylene glycol mono-hexyl ether and di-ethylene glycol mono-hexyl ether, and mixtures thereof can be used in minimal amounts. “Butyl” includes both normal butyl, isobutyl and tertiary butyl groups. The compositions will be free of hydrocarbon solvents including C₅-C₁₆ alkane and aromatic solvents. In general, the water content of the formulations will range from about 30 to 98 wt. %. Detergent type formulations such as for hand dish washing or laundry detergents will have a water content up to about 80 wt. %, whereas hard surface cleaning formulations can have water contents of from 80 to 98 wt. %.

The compositions of this invention include an alkyl polyglycoside nonionic surfactant. The alkyl polyglycosides which can be used in the surfactant mixture according to the present invention correspond to formula I:

R₁O(R₂O)_{b}(Z)ₐ (I)

wherein R₁ is a monovalent organic radical having from about 6 to about 30 carbon atoms, once again depending on which starting material is used; R₂ is a divalent alkylene radical having from 2 to 4 carbon atoms; Z is a saccharide residue having 5 or 6 carbon atoms; b is a number having a value from 0 to about 12; a is a number having a value from 1 to about 6. Preferred alkyl polyglycosides which can be used in the compositions according to the invention have the formula I wherein Z is a glucose residue and b is zero. Such alkyl polyglycosides are commercially available, for example, as APG®, GLUCOPON®, or PLANTAREN® surfactants from Henkel Corporation, Ambler, Pa., 19002. Examples of such surfactants include but are not limited to:

1. APG® 225 Surfactant—an alkyl polyglycoside in which the alkyl group contains 8 to 10 carbon atoms and having an average degree of polymerization of 1.7.

2. APG® 425 Surfactant—an alkyl polyglycoside in which the alkyl group contains 8 to 16 carbon atoms and having an average degree of polymerization of 1.6.

3. APG® 625 Surfactant—an alkyl polyglycoside in which the alkyl group contains 12 to 16 carbon atoms and having an average degree of polymerization of 1.6.

4. APG® 325 Surfactant—an alkyl polyglycoside in which the alkyl group contains 9 to 11 carbon atoms and having an average degree of polymerization of 1.6.

5. GLUCOPON® 600 Surfactant—an alkyl polyglycoside in which the alkyl group contains 12 to 16 carbon atoms and having an average degree of polymerization of 1.4.

6. PLANTAREN® 2000 Surfactant—a C₈₋₁₆ alkyl polyglycoside in which the alkyl group contains 8 to 16 carbon atoms and having an average degree of polymerization of 1.4.

7. PLANTAREN® 1300 Surfactant—a C₁₂₋₁₆ alkyl polyglycoside in which the alkyl group contains 12 to 16 carbon atoms and having an average degree of polymerization of 1.6.

Other examples include alkyl polyglycoside surfactant compositions which are comprised of mixtures of compounds of formula I wherein Z represents a moiety derived from a reducing saccharide containing 5 or 6 carbon atoms; a is a number having a value from 1 to about 6; b is zero; and R₁ is an alkyl radical having from 8 to 20 carbon atoms. The compositions are characterized in that they have increased surfactant properties and an HLB in the range of about 10 to about 16 and a non-Flory distribution of glycosides, which is comprised of a mixture of an alkyl monoglycoside and a mixture of alkyl polyglycosides having varying degrees of polymerization of 2 and higher in progressively decreasing amounts, in which the amount by weight of polyglycoside having a degree of polymerization of 2, or mixtures thereof with the polyglycoside having a degree of polymerization of 3, predominate in relation to the amount of monoglycoside, said composition having an average degree of polymerization of about 1.8 to about 3. Such compositions, also known as peaked alkyl polyglycosides, can be prepared by separation of the monoglycoside from the original reaction mixture of alkyl monoglycoside and alkyl polyglycosides after removal of the alcohol. This separation may be carried out by molecular distillation and normally results in the removal of about 70-95% by weight of the alkyl monoglycosides. After removal of the alkyl monoglycosides, the relative distribution of the various components, mono- and poly-glycosides, in the resulting product changes and the concentration in the product of the polyglycosides relative to the monoglycoside increases as well as the concentration of individual polyglycosides to the total, i.e. DP2 and DP3 fractions in relation to the sum of all DP fractions. Such compositions are disclosed in U.S. Pat. No. 5,266,690, the entire contents of which are incorporated herein by reference.

Other alkyl polyglycosides which can be used in the compositions according to the invention are those in which the alkyl moiety contains from 6 to 18 carbon atoms in which the average carbon chain length of the composition is from about 9 to about 14 comprising a mixture of two or more of at least binary components of alkylpolyglycosides, wherein each binary component is present in the mixture in relation to its average carbon chain length in an amount effective to provide the surfactant composition with the average carbon chain length of about 9 to about 14 and wherein at least one, or both binary components, comprise a Flory distribution of polyglycosides derived from an acid-catalyzed reaction of an alcohol containing 6-20 carbon atoms and a suitable saccharide from which excess alcohol has been separated.

The preferred alkyl polyglycosides are those of formula I wherein R₁ is based on a coconut fatty alcohol midcut corresponding to a monovalent organic radical having a C_{12/14/16} carbon chain length distribution; b is zero; Z is a glucose residue having 5 or 6 carbon atoms; and a is a number having a value of from 1 to about 2.

In general, the amount of the alkyl polyglycoside present in the composition of this invention will vary between 1 to 40 wt. % depending upon the purpose of the composition. For detergents such as for hand washing of dishes or laundry detergents, the amount of nonionic APG surfactant will be on the upper end of range or from about 10 to 40 wt. %. For hard surface cleaning formulations such for cleaning glass appliances, counter tops, etc., 1 to less than 10 wt. % of APG is useful.

Alkyl amphocarboxylate surfactants will also be included in the composition and may function as anionic, cationic or nonionic surfactants, depending on the pH of the medium in which they are present. Alkyl amphoacetates are widely used in cosmetic formulations such as shampoos or cleansing detergents, because of their mildness, safety and lack of irritating effects on skin and eyes. Furthermore they are said to actually reduce the skin and eye irritating effects of other surfactants with which they are used. Alkyl amphoacetates also have excellent surface active properties such as surface tension reduction, and excellent foaming and wetting properties. Because of their biodegradability, lack of skin irritation and unique ability to reduce the irritancy of more aggressive surfactants, alkyl amphoacetate surfactants have gained wide use as secondary surfactants in the personal care industry. Furthermore, because of their hydrolytic stability and compatibility with electrolytes, alkyl amphoacetates have also been used in household and industrial cleaner formulations.

Alkyl amphoacetate surfactants, e.g. those sold under the registered Trade Mark “Miranol”, are customarily made by reacting long chain fatty acids, e.g. in the form of the mixture known as “coconut fatty acids”, with aminoethylethanolamine (AEEA), and reacting the product with a haloacetic acid or salt thereof in the presence of an alkali (see, for example, Kirk-Othmer's Encyclopedia of Chemical Technology Third Edition (Wiley & Sons) Vol. 22, pages 385 and 386 and U.S. Pat. Nos. 2,528,378 or 2,773,068).

A particularly useful alkyl amphoacetate surfactant that can be included in the composition of this invention is sodium lauroampho acetate. However, alkyl amphoacetates with longer alkyl chains such as sodium cocoalkyl amphoacetate may have benefits in some formulations. The alkyl amphoacetate surfactant will be present in amounts of from 1 to 25 wt. %. Again, larger amounts within the range will be used for detergent type compositions, typically 5 to 25 wt. %, while lower levels, e.g. 1 to 5 wt. % will be used for other types of cleaners.

Among other alkyl amphocarboxylate surfactants useful for this invention are sodium alkyl amphopropionate, disodium alkyl amphodipropionate and disodium alkyl diacetate.

The composition according to the invention can include complexing or chelating agents that aid in reducing the harmful effects of hardness components in ordinary household (tap) water, or other heavy metals which bind soils to surfaces. Typically, calcium, magnesium, iron, manganese, or other polyvalent metal cations, present in tap water, can interfere with the action of either washing compositions or rinsing compositions. A chelating agent is provided for complexing with the metal cations and preventing the complexed metal cations from interfering with the action of active cleaning components of the composition. Both organic and inorganic chelating agents are common. Inorganic chelating agents include such compounds as sodium pyrophosphate, sodium tripolyphosphate and sodium hexametaphosphate. However, while the complex phosphates are excellent detergent adjuvants, the levels of these ingredients are desirably minimized because of their potential adverse effects on waste water. Thus, phosphates are known to promote eutrophication of lakes and rivers. Organic chelating agents include small molecule chelating agents. Small molecule organic chelating agents include salts of ethylenediaminetetracetic acid (EDTA) and hydroxyethylenediaminetetracetic acid, nitrilotriacetic acid, ethylenediaminetetrapropionates, triethylenetetraminehexacetates, and the respective alkali metal ammonium and substituted ammonium salts thereof. Naturally derived chelating agents that are biodegradable are preferred including sodium citrate and sodium iminodisuccinate.

The amount of chelating agent that may be present in the compositions of the present invention may vary from about 0.1 to about 15 wt. %.

The aqueous cleaning compositions of the present invention may also include a preservative. Preferably the preservative chosen should be natural or naturally derived. Many preservatives are alleged to be potentially harmful to human health. Therefore the preservative selected should be carefully chosen and the level used be the minimum amount needed to preserve the formulation. Most preservatives are useful in the acidic range and are not effective at pHs much above 6.0. The preservatives most preferably used in the present invention are also effective in the alkaline range and are based upon an amino acid. Thus, the preferred preservative is monosodium N-hydroxymethyl glycine. In general, the preservative will be present in amounts ranging from 0.01 to 1% by weight.

If the surfactant composition yields a pH which is too elevated or too acidic, a buffer can be incorporated into the composition. Buffering agents are well known in the detergent art. In accordance with this invention, in order to maintain a mild product derived from natural sources, the buffering agent typically used, if needed in this composition, will be baking soda (sodium bicarbonate) and/or sodium carbonate. The amount of the buffering agent can vary generally between 0.1 and 7 wt. % depending upon the use of the formulation and the desired pH. It is useful to provide a formulation pH which will range from about 7 to 10 and, more preferably, from about 7 to about 9. Compositions having a pH of 7 to less than 9 are particularly preferred. While baking soda is a useful buffer, it can also be an important builder for use in formulations which are provided as laundry detergent compositions. While other buffers could be used in formulations of this invention, a special advantage of baking soda is that it is already in an ultimate state of biodegradation and therefore does not present any kind of burden on the environment.

It is common to add a fragrance to cleaning compositions to provide a pleasant odor to the composition itself, and it often provides a residual pleasant odor on the surface being cleaned. Natural fragrances such as essential oils are preferred in the composition of this invention. Essential oils include, but are not limited to, those obtained from thyme, lemongrass, citrus, lemons, oranges, anise, clove, aniseed, pine, cinnamon, geranium, roses, mint, lavender, citronella, eucalyptus, peppermint, camphor, sandalwood, rosmarin, vervain, fleagrass, lemongrass, ratanhiae, cedar and mixtures thereof.

Other essential oils include Anethole 20/21 natural, Aniseed oil china star, Aniseed oil globe brand, Balsam (Peru), Basil oil (India), Black pepper oil, Black pepper oleoresin 40/20, Bois de Rose (Brazil) FOB, Borneol Flakes (China), Camphor oil, Camphor powder synthetic technical, Canaga oil (Java), Cardamom oil, Cassia oil (China), Cedarwood oil (China) BP, Cinnamon bark oil, Cinnamon leaf oil, Citronella oil, Clove bud oil, Clove leaf, Coriander (Russia), Coumarin (China), Cyclamen Aldehyde, Diphenyl oxide, Ethyl vanilin, Eucalyptol, Eucalyptus oil, Eucalyptus citriodora, Fennel oil, Geranium oil, Ginger oil, Ginger oleoresin (India), White grapefruit oil, Guaiacwood oil, Gurjun balsam, Heliotropin, Isobornyl acetate, Isolongifolene, Juniper berry oil, L-methyl acetate, Lavender oil, Lemon oil, Lemongrass oil, Lime oil distilled, Litsea Cubeba oil, Longifolene, Menthol crystals, Methyl cedryl ketone, Methyl chavicol, Methyl salicylate, Musk ambrette, Musk ketone, Musk xylol, Nutmeg oil, Orange oil, Patchouli oil, Peppermint oil, Phenyl ethyl alcohol, Pimento berry oil, Pimento leaf oil, Rosalin, Sandalwood oil, Sandenol, Sage oil, Clary sage, Sassafras oil, Spearmint oil, Spike lavender, Tagetes, Tea tree oil, Vanilin, Vetyver oil (Java), and Wintergreen. Each of these botanical oils is commercially available.

It may be necessary to include in the composition an agent to disperse the natural fragrance into the aqueous-based cleaning formulations, as many of the essential oils are not readily soluble in water. Thus, one or more dispersing agents may be useful additions to the composition of this invention.

Suitable dispersants include, but are not limited to, sorbitol derivatives, such as sorbitan monolaurate, and polysorbate 20, polysorbate 21 or polysorbate 60; lecithin and lecithin derivatives; ethoxylated alcohols such as laureth-23, ethoxylated fatty acids such as PEG-1000 stearate, PEG-20 methyl glucose sesquistearate, PEG-80 glyceryl cocoate, PEG-20 sorbitan isostearate, and PEG-120 methyl glucose dioleate; amidoamine derivatives such as stearamidoethyl diethylamine; sulfates of alcohols, such as sodium lauryl sulfate; phosphate esters such as DEA cetyl phosphate and potassium stearyl phosphate; glyceryl esters, such as polyglyceryl-2 PEG-4 stearate and polyglyceryl-2 sesquistearate; polymeric esters, such as poloxamers 181, 184, 105, 124, 401, and 407; amido-sulfonic acid derivatives, such as sodium methyl cocoyl taurate; sulfosuccinates, such as disodium ricinoleamido MEA-sulfosuccinate, fatty acid amine salts such as TEA stearate and stearamide MEA stearate; sarcosine derivatives, such as sodium cocoyl sarcosinate, and mixtures thereof. However, in keeping with the gentle nature of the cleansing components, a very mild emulsifier is preferred. Since ethoxylated surfactants can contain significant concentrations of 1,4-dioxane as a byproduct of the ethoxylation process, it is desirable to utilize a grade which has been treated to remove as much 1,4-dioxane as possible, for example by vacuum distillation. A particularly preferred dispersing agent is a pure grade of polysorbate 20, often sold under the trade name Tween 20. This ethoxylated dispersant is carefully treated to remove as much 1.4 dioxane as possible. This dispersant is highly effective at low concentrations. Therefore its use introduces minimal, if any, levels of 1.4 dioxane into the formulation.

The compositions of this invention may also include a hydrotrope to reduce the viscosity of the formulation. In general, without an organic polar solvent, the viscosity of the composition may be too thick, as often, the alkyl polyglcoside surfactant will raise the viscosity of the formulation. If the organic polar solvent is not included to reduce the viscosity, a small amount of a naturally derived dispersant, as above described, can be used.

The formulations of this invention can be applied from any known container including bottles with pour spouts, squeeze bottles, containers with spray nozzles, etc.

The cleaning composition may also be part of a cleaning substrate. A wide variety of materials can be used as the cleaning substrate. The substrate should have sufficient wet strength, abrasivity, loft and porosity. Examples of suitable substrates include, nonwoven substrates, wovens substrates, hydroentangled substrates, foams and sponges. Any of these substrates may be water-insoluble, water-dispersible, or water-soluble.

In one embodiment, the cleaning pad may comprise a nonwoven substrate or web. The substrate is composed of nonwoven fibers or paper. The term nonwoven is to be defined according to the commonly known definition provided by the “Nonwoven Fabrics Handbook” published by the Association of the Nonwoven Fabric Industry. A paper substrate is defined by EDANA (note 1 of ISO 9092-EN 29092) as a substrate comprising more than 50% by mass of its fibrous content is made up of fibers (excluding chemically digested vegetable fibers) with a length to diameter ratio of greater than 300, and more preferably also has density of less than 0.040 g/cm³. The definitions of both nonwoven and paper substrates do not include woven fabric or cloth or sponge. The substrate can be partially or fully permeable to water. The substrate can be flexible and the substrate can be resilient, meaning that once applied external pressure has been removed the substrate regains its original shape.

Methods of making nonwovens are well known in the art. Generally, these nonwovens can be made by air-laying, water-laying, meltblowing, coforming, spunbonding, or carding processes in which the fibers or filaments are first cut to desired lengths from long strands, passed into a water or air stream, and then deposited onto a screen through which the fiber-laden air or water is passed. The air-laying process is described in U.S. Pat. App. 2003/0036741 to Abba et al. and U.S. Pat. App. 2003/0118825 to Melius et al. The resulting layer, regardless of its method of production or composition, is then subjected to at least one of several types of bonding operations to anchor the individual fibers together to form a self-sustaining substrate. In the present invention the nonwoven substrate can be prepared by a variety of processes including, but not limited to, air-entanglement, hydroentanglement, thermal bonding, and combinations of these processes.

Additionally, the first layer and the second layer, as well as additional layers, when present, can be bonded to one another in order to maintain the integrity of the article. The layers can be heat spot bonded together or using heat generated by ultrasonic sound waves. The bonding may be arranged such that geometric shapes and patterns, e.g. diamonds, circles, squares, etc. are created on the exterior surfaces of the layers and the resulting article.

The cleaning substrates can be provided dry, pre-moistened, or impregnated with cleaning composition, but dry-to-the-touch. In one aspect, dry cleaning substrates can be provided with dry or substantially dry cleaning or disinfecting agents coated on or in the multicomponent multilobal fiber layer. In addition, the cleaning substrates can be provided in a pre-moistened and/or saturated condition. The wet cleaning substrates can be maintained over time in a sealable container such as, for example, within a bucket with an attachable lid, sealable plastic pouches or bags, canisters, jars, tubs and so forth. Desirably the wet, stacked cleaning substrates are maintained in a resealable container. Exemplary resealable containers and dispensers include, but are not limited to, those described in U.S. Pat. No. 4,171,047 to Doyle et al., U.S. Pat. No. 4,353,480 to McFadyen, U.S. Pat. No. 4,778,048 to Kaspar et al., U.S. Pat. No. 4,741,944 to Jackson et al., U.S. Pat. No. 5,595,786 to McBride et al.; the entire contents of each of the aforesaid references are incorporated herein by reference. The cleaning substrates can be incorporated or oriented in the container as desired and/or folded as desired in order to improve ease of use or removal as is known in the art. The cleaning substrates of the present invention can be provided in a kit form, wherein a plurality of cleaning substrates and a cleaning tool are provided in a single package.

The substrate can include both natural and synthetic fibers. Biodegradable fibers are preferred. The substrate can also include water-soluble fibers or water-dispersible fibers, from polymers described herein. The substrate can be composed of suitable unmodified and/or modified naturally occurring fibers including cotton, Esparto grass, bagasse, hemp, flax, silk, wool, wood pulp, chemically modified wood pulp, jute, ethyl cellulose, and/or cellulose acetate. Various pulp fibers can be utilized including, but not limited to, thermomechanical pulp fibers, chemi-thermomechanical pulp fibers, chemi-mechanical pulp fibers, refiner mechanical pulp fibers, stone groundwood pulp fibers, peroxide mechanical pulp fibers and so forth.

Suitable synthetic fibers can comprise fibers of one, or more, of polyvinyl chloride, polyvinyl fluoride, polytetrafluoroethylene, polyvinylidene chloride, polyacrylics such as ORLON®, polyvinyl acetate, Rayon®, polyethylvinyl acetate, non-soluble or soluble polyvinyl alcohol, polyolefins such as polyethylene (e.g., PULPEX®) and polypropylene, polyamides such as nylon, polyesters such as DACRON® or KODEL.®, polyurethanes, polystyrenes, and the like, including fibers comprising polymers containing more than one monomer.

The cleaning substrate of this invention may be a multilayer laminate and may be formed by a number of different techniques including but not limited to using adhesive, needle punching, ultrasonic bonding, thermal calendaring and through-air bonding. Such a multilayer laminate may be an embodiment wherein some of the layers are spunbond and some meltblown such as a spunbond/meltblown/spunbond (SMS) laminate as disclosed in U.S. Pat. No. 4,041,203 to Brock et al. and U.S. Pat. No. 5,169,706 to Collier, et al., each hereby incorporated by reference. The SMS laminate may be made by sequentially depositing onto a moving conveyor belt or forming wire first a spunbond web layer, then a meltblown web layer and last another spunbond layer and then bonding the laminate in a manner described above. Alternatively, the three web layers may be made individually, collected in rolls and combined in a separate bonding step.

The substrate may also contain superabsorbent materials. A wide variety of high absorbency materials (also known as superabsorbent materials) are known to those skilled in the art. See, for example, U.S. Pat. No. 4,076,663 issued Feb. 28, 1978 to Masuda et al, U.S. Pat. No. 4,286,082 issued Aug. 25, 1981 to Tsubakimoto et al., U.S. Pat. No. 4,062,817 issued Dec. 13, 1977 to Westerman, and U.S. Pat. No. 4,340,706 issued Jul. 20, 1982 to Obayashi et al. The absorbent capacity of such high-absorbency materials is generally many times greater than the absorbent capacity of fibrous materials. For example, a fibrous matrix of wood pulp fluff can absorb about 7-9 grams of a liquid, (such as 0.9 weight percent saline) per gram of wood pulp fluff, while the high-absorbency materials can absorb at least about 15, preferably at least about 20, and often at least about 25 grams of liquid, such as 0.9 weight percent saline, per gram of the high-absorbency material. U.S. Pat. No. 5,601,542, issued to Melius et al., discloses an absorbent article in which superabsorbent material is contained in layers of discrete pouches. Alternately, the superabsorbent material may be within one layer or dispersed throughout the substrate.

The following examples set forth non-limiting aqueous cleaning formulations within the scope of this invention.

### EXAMPLE 1

The following is useful as a hand dish washing formula. The composition has been found particularly useful for removing milk residues from glass and plastic.

| | % |
|---|---|
| Water | 58.15 |
| Sodium citrate | 2.5 |
| Baking soda | 2 |
| ¹Baypure CX100 (34%)^{a} | 2 |
| ²Integra 44 (50%)^{a} | 0.35 |
| ³Mackam HPL-32 (32%)^{a} | 18 |
| Lavender | 0.3 |
| ⁴Tween 20 | 0.2 |
| ⁵Mackanate RM | 1.5 |
| ⁶Glucopon 600 UP (50%)^{a} | 15 |
| Total | 100 |

^{a}(wt. % active)
¹Sodium iminodisuccinate, Lanxess, Leverkuson, Germany
²Glycine N-(hydroxymethyl)-monosodium salt
³Sodium lauroampho acetate, McIntyre Group Ltd., University Park, IL
⁴An essentially dioxane-free grade of Polysorbate 20 (Polyoxyethylene sorbitan monolaurate)
⁵Disodium ricinoleamido MEA sulfosuccinate, McIntyre Group Ltd.
⁶A mixture of D-glucopyranose, oligomeric alkyl (C10-C16) glycosides, Cognis Corp., Ambler, PA.

### EXAMPLE 2

The following formulation can be applied directly to clean a surface or impregnated onto a fabric or porous substrate and wiped onto a toy surface for cleaning.

Toy Cleaner Formulation

| | |
|---|---|
| ¹Glucopon 425 UP | 1.5 |
| Mackam HPL 32 | 2.5 |
| Baking Soda | 0.2 |
| Sodium Citrate | 0.2 |
| Integra 44 | 0.35 |
| Lavender | 0.03 |
| Ethyl alcohol SDA 40B | 0.05 |
| Water | 95.17 |
| Total | 100 |

¹A mixture of C₈-C₁₀, and C₁₀-C₁₆, alkyl polyglycosides, Cognis

### EXAMPLE 3

Window Cleaner Formulation

| | |
|---|---|
| Glucopon 425 UP | 3 |
| Mackam HPL 32 | 1 |
| Baking Soda | 0.4 |
| Sodium Citrate | 0.5 |
| Integra 44 | 0.35 |
| Fragrance | 0.02 |
| Dipropylene glycol | 0.05 |
| Water | 94.68 |
| Total | 100 |

### EXAMPLE 4

All Purpose Cleaner Formulation

| | |
|---|---|
| Glucopon 425 UP | 6 |
| Mackam HPL 32 | 2 |
| Baking Soda | 0.4 |
| Sodium Citrate | 1 |
| Integra 44 | 0.35 |
| Lavender | 0.03 |
| Water | 90.22 |
| Total | 100 |

### EXAMPLE 5

Heavy Duty Concentrated Liquid Laundry Detergent

| | |
|---|---|
| Glucopon 600 UP | 30.0 |
| ¹Miranol JEM Conc | 10.0 |
| Sodium carbonate | 1.5 |
| Baking Soda | 2.0 |
| Sodium citrate | 5.0 |
| Integra 44 | 0.3 |
| Lavender | 0.3 |
| Water | 50.9 |
| Total | 100 |

¹A mixed alkyl amphocarboxylate, Rhodia

1. An aqueous-based cleaning composition comprising: a) a surfactant combination consisting essentially of an alkyl polyglycoside nonionic surfactant; and an alkyl amphocarboxylate amphoteric surfactant, and b) 0 to less than 1 wt.% of a polar organic solvent, said cleaning composition being free of hydrocarbon solvents.

2. The composition of claim 1, wherein said alkyl amphocarboxylate surfactant is an alkyl amphoacetate, alkyl amphodiacetate, alkyl amphoproprionate or alkyl amphodipropionate.

3. The composition of claim 1, wherein said alkyl polyglycoside has an alkyl group of 8 to 16 carbon atoms.

4. The composition of claim 1 including a chelating agent.

5. The composition of claim 4, wherein said chelating agent is sodium citrate, sodium iminodisuccinate, or mixtures thereof.

6. The composition of claim 1 including 0.1 to 7 wt. % baking soda.

7. The composition of claim 1 containing an amino acid derived preservative.

8. The composition of claim 1 including an essential oil fragrance.

9. The composition of claim 8, wherein the essential oil fragrance is lavender.

10. The composition of claim 8, comprising a dispersing agent.

11. The composition of claim 1, which is free of ethoxylated surfactants.

12. The composition of claim 1, containing 30 to 98 wt. % water.

13. The composition of claim 12, including a chelating agent.

14. The composition of claim 13, wherein said chelating agent is sodium citrate, sodium iminodisuccinate, or mixtures thereof.

15. The composition of claim 14 including 0.1 to 7 wt. % baking soda.

16. The composition of claim 15 further including an essential oil fragrance.

17. The composition of claim 1, including a positive amount up to 1 wt. % of said polar organic solvent.

18. The composition of claim 17, wherein said polar organic solvent is ethyl alcohol or dipropylene glycol.

19. The composition of claim 1, impregnated or coated onto a porous substrate.

20. The composition of claim 19, wherein said porous substrate is composed of non-woven fibers or paper.
